(19) United States
(12) Patent Application Publication
(10) Pub. No.: US 2002/0014163 A1
(43) Pub. Date: Feb. 7, 2002

(54) Flare-up suppressing cooking grill device

(76) Inventor: Darryl L. Clark, Mesa, AZ (US)

Correspondence Address: Sherman D. Pernia, Suite 450, 1110 NASA Road ONE, Houston, TX, 77058-3310, US

(21) Appl. No.: 09/871,404

(22) Filed: May 31, 2001

Related U.S. Application Data
(60) Provisional application No. 60/222,239, filed on Aug. 1, 2000.

(51) Int. Cl. A47J 37/08; H05B 1/00; A47J 27/00; A47J 9/00

(52) U.S. Cl. 99/446; 99/400; 99/401; 99/447

(57) ABSTRACT

A combination base plate and heat exchanger accessory are inserted into an existing cooking grill between the cooking area and the heat source of the cooking grill to suppress or prevent flame flare-ups caused by ignition of drippings. The bottom surface of the base plate is disposed in close proximity to the heat source of the cooking grill. The heat exchanger has an upper surface that is corrugated or channeled, to catch drippings and conduct them away from the surface of the heat exchanger to a drip edge disposed along a perimeter edge of the heat exchanger. The drippings are thus prevented from contacting the heat source of the cooking grill and causing flame flare-ups which may singe or burn the foodstuff being cooked.

### BACKGROUND OF THE INVENTION

A popular method of food preparation is barbequing or grilling of the food in a cooking grill having a housing containing a food support positioned over a heat source. Additionally, the housing has a lid or cover for accessing or closing off the cooking area. Such cooking grills typically are fueled by gas (e.g. methane, propane, butane or the like) or by charcoal. Although flammable gas and charcoal are the prevalent fuels for such grills, liquid fuels (e.g., white gas) can also be used.

The heat source in such cooking grills is generally configured in a horizontal plane, for example, as in a bed of charcoal in a charcoal grill, or the horizontal burners for a gas grill. The heat source provides heat which is directed or transferred to the cooking area. Foodstuffs located in the cooking area are then cooked by the heat. Outdoor cooking or barbeque grills are well known in the art. For gas cooking grills, the heat source typically includes a control assembly connecting a fuel source and the fuel burner, and can also include a means for concentrating or collecting the heat such as metal plates or ceramic briquettes (e.g. lava rocks), which are substantially in direct contact with the ignited fuel. In a charcoal fueled grill, the mass of the briquettes themselves act as heat collectors.

A principle means of directing the heat from the heat source to the cooking support is accomplished by having the cooking support directly above the heat source, in order to directly expose the food to heat from the heat source. The cooking support generally consists of a food grill or food grate which is typically a metal panel with open spaces in it, on top of which the foodstuff is placed to cook. The food support defines the cooking area of the cooking apparatus. However, in this configuration, any juices from the cooking foodstuff can drip through the spaces in the food grill and fall directly onto the heat source. The direct exposure of the drippings to the heat source can cause ignition of the drippings, resulting in flame flare-ups. The flare-ups cause uneven heating of the cooking area, scorching and the deposit of excess pyrolysis products on the cooking food.

Various examples of cooking grills and cooking grill attachments have attempted to overcome this problem. Such an example is Miller, U.S. Pat. No. 4,428,281, which describes a food support with uniformly distributed openings and grooves. The grooves slope, and direct the majority of the liquids away from the heat source. Another example is Vitacca, U.S. Pat. No. 5,655,437 describing a system which includes a side burner for charcoal, a lower grill structure and an upper grill structure supporting the side burner. The system provides a charcoal grill which prevents flames from singeing food or flaring toward the user.

Still another example is Johnston, U.S. Pat. No. 5,613,486, a heating system for a barbecue grill, kitchen range, water heater and other devices. The system is a U shaped burner which is protected by a shield from drippings, facilitating grease removal and helping to prevent flare-ups. Koziol, U.S. Pat. No. 5,467,691 describes a two-sided food support grid for a barbecue grill, one for cooking larger pieces of food, the other for cooking smaller pieces of food. The grid also directs juices and fats from the cooked items away from the heat source.

### SUMMARY OF THE INVENTION

The present invention is an accessory device for use with a cooking grill, such as the typical outdoor gas barbeque or charcoal cooking grill. The object of the present invention is to reduce or eliminate the flame flare-ups that can occur in such a cooking grill when drippings from the foodstuff being cooked come into direct contact with the heat source in the cooking grill. This object is accomplished by placing the present cooking grill insert device between the heat source and the food support on which the foodstuff is placed for cooking. The grill insert device catches the drippings from the food as it cooks, preventing the drippings from directly contacting the heat source. The caught drippings are then channeled away from the hottest part of the heat source. In this manner, the frequency or severity of flame flare-ups can be suppressed or eliminated.

The present invention can be used with existing gas or charcoal cooking grills and similar apparatuses. The flare-up suppressing device is inserted into an existing cooking grill and positioned between the food support (or food grill/grate) and the heat source. The present flare-up suppressing device comprises a base plate and a heat exchanger that are stacked and placed in combination between the heat source and the food grate of a barbeque-type cooking grill.

The heat exchanger sits on top of and in close contact with the base plate. The bottom surface of the base plate is disposed in close proximity to the heat source of the grill. The heat exchanger has an upper surface that is corrugated or channeled, to catch drippings and conduct them away from the surface of the heat exchanger to a drip edge disposed along a perimeter edge of the heat exchanger. The drippings are then drained away and prevented from contacting the heat source of the grill. The lower surface of the heat exchanger is also corrugated or channeled and therefore directly contacts the base plate at intervals.

The present flare-up suppressing device for suppressing flame flare-ups in a cooking grill has two primary components. The device has a base plate and a heat exchanger, both made of metal. In use, the base plate of the present device is placed above the heat source with its bottom surface in close proximity to the heat source.

The base plate has a top surface and a bottom surface. Typically, the base plate is made of a steel plate, and generally has a thickness ranging from about ¼ inch to about 7/16 inch. Base plates having ¼ and ⅜ inch thickness have been practiced with good success in the present invention. Optionally, the base plate may include stand-offs or legs. These features can be particularly useful when the present grill insert device is used with a charcoal-type cooking grill to maintain the grill insert's position inside the housing of the cooking grill.

The heat exchanger has an upper surface, a lower surface and a perimeter edge. The upper surface of the heat exchanger has features in it to facilitate the flow of liquids (e.g., drippings) that fall onto it toward a perimeter edge. These flow features can be channels, grooves, corrugations or the like which are in liquid flow communication with the perimeter edge. The lower surface of the heat exchanger is also variegated a surface and directly interfaces with the top surface of the base plate in a spaced pattern. The heat exchanger receives heat from the base plate and communicates it to the food support in the cooking area of the cooking grill. The heat exchanger is made of cast iron. The overall surface area of the present device can be substantially similar to the full surface area of the heat source. Alternatively, the overall surface area of the present device may be less than that of the heat source, to allow part of the food support to be directly heated by the heat source, or to allow direct access to the heat source (e.g., to expose wood chips to the heat source).

A drip edge is disposed along at least part of the perimeter edge of the heat exchanger. The drip edge can merely be an open edge of the heat exchanger to allow drippings to fall from the channels into the cooking grill housing. Alternatively, the drip edge is a trough along at least part of the perimeter edge in which drippings collect as they pass from the channels. Where the drip edge is a trough in which drippings collect as they pass from the channels, the trough may have a passage or opening through which the dripping can pass from the device into a separate container or into the bottom of the grill housing.

Although the present flame flare-up suppressing cooking grill device is intended as an accessory to be inserted into the housing of an existing cooking grill, it can be incorporated into such a cooking grill on manufacture as well.

### BRIEF DESCRIPTION OF THE DRAWINGS

FIG. 1A is a top view of a typical cooking grill showing the housing having a lid in the open position, and showing the placement of the present grill device beneath the food support of the cooking grill.

FIG. 1B is a front view of the components inside the cooking grill housing showing the placement of the present grill device above the heat source and beneath the food support.

FIG. 2A is an expanded perspective view of the present grill device showing the metal base plate and the heat exchanger positioned over the heat source in a cooking grill.

FIG. 2B is a partial cross section of the grill insert showing the relationship of the base plate to the drip edge of the heat exchanger.

FIG. 3 is a partial perspective view of the grill insert showing use of legs or standoffs with the base plate.

### DETAILED DESCRIPTION OF THE INVENTION

In a preferred embodiment, the present invention is an accessory device or assembly which is insertable into an existing cooking grill to suppress or prevent flame flare-ups caused by ignition of drippings from the food being cooked. The grill insert is designed to sit over the cooking grill's heat source and to distribute heat to the food grill of the cooking area by means of a heat exchanger. The present device has a planar configuration. In this preferred embodiment, the insert has a surface area substantially corresponding to the surface area and configuration of the cooking area of the grill, allowing the insert to catch drippings from any part of the cooking area.

Referring now to the drawings, the details of preferred embodiments of the present invention are graphically and schematically illustrated. Like elements in the drawings will be represented by like numbers, and any similar elements will be represented by like numbers with a different lower case letter suffix.

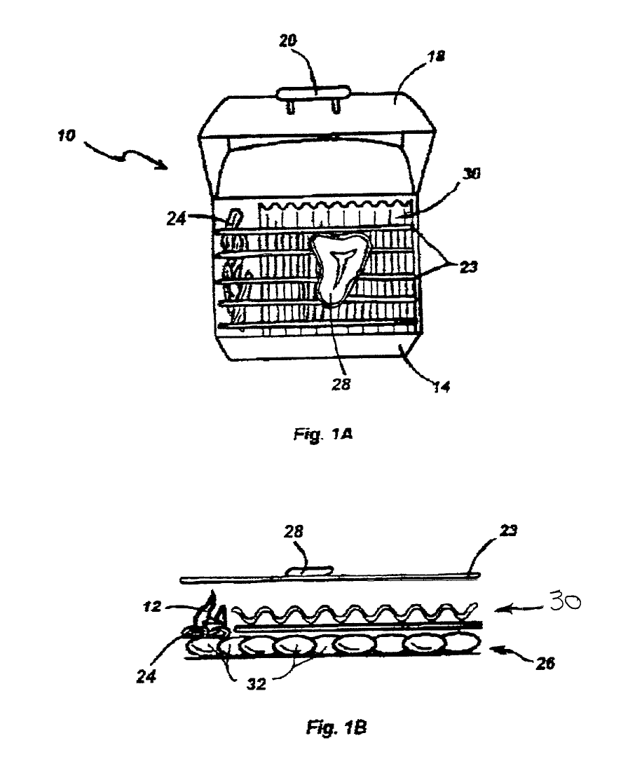

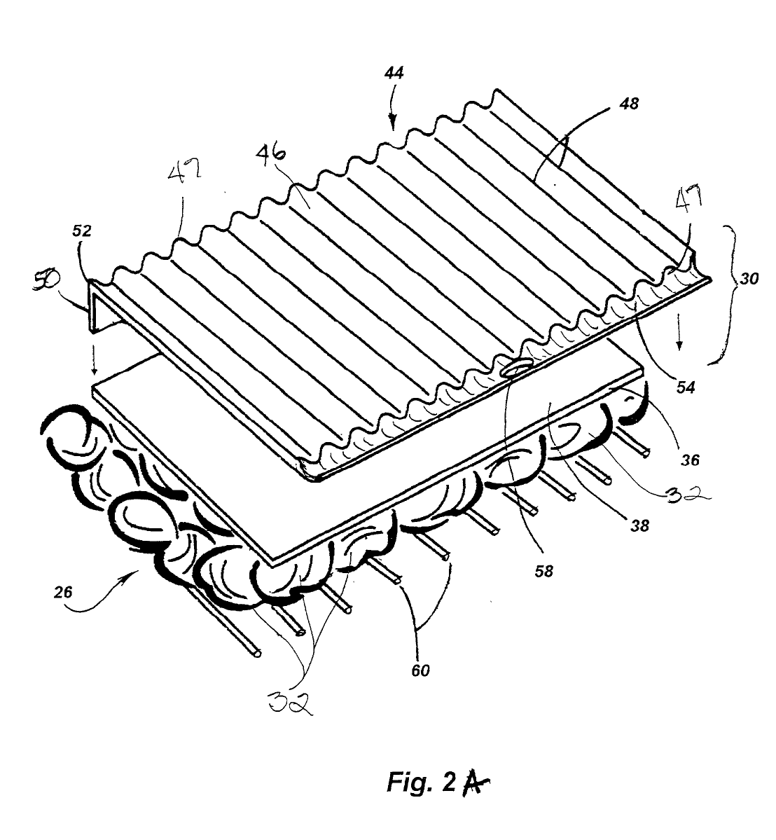

As shown in FIGS. 1A and 1B, in one preferred embodiment, the present invention is a cooking grill insert accessory 30 for use in a cooking grill 10, such as a gas or charcoal barbeque grill. The insert device 30 protects foodstuff 28 being cooked on the grill 10 from the flare-up of flames 12 due to the igniting of drippings (not shown) from cooking foodstuff 28. The present flare-up suppressing device has two primary components: a base plate 36 and a heat exchanger 44, both made of metal (see FIG. 2A). Additionally, the heat exchanger 44 of the insert device 30 includes a drip edge feature 52.

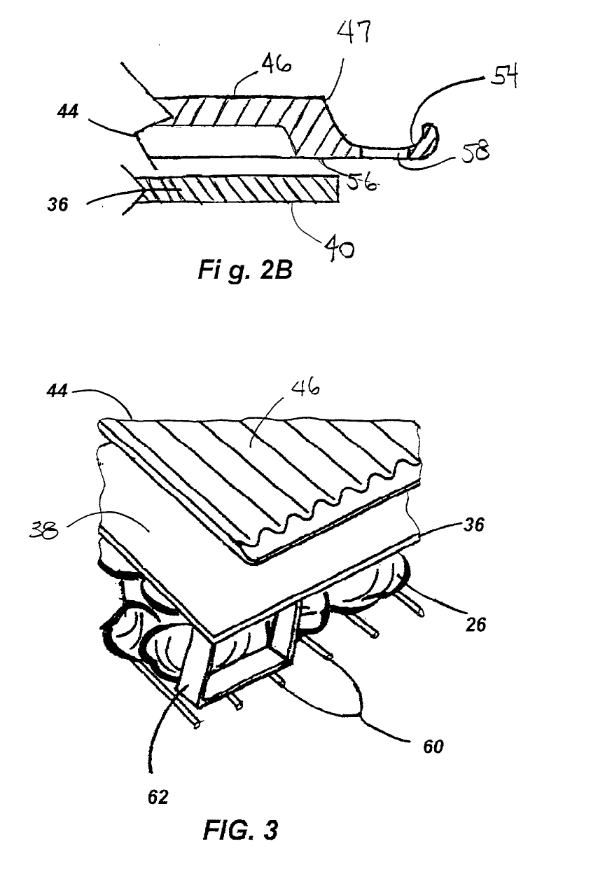

As shown in FIGS. 2A and 2B, the base plate 36 component of the insert device 30 has a top surface 38 and a bottom surface 40. Typically, the base plate 36 is made of steel plate, and generally has a thickness ranging from about ¼ inch to about 7/16 inch. A base plate having a ⅜ inch thick steel plate has been practiced with good success in the present invention. The exact material and dimensions of the base plate 36 are readily selectable by one of ordinary skill in the art in view of the figures and teachings set forth herein. Optionally, as shown in FIG. 3, the base plate 36 may include stand-offs or legs 62. The stand-offs or legs 62 are particularly useful when the present grill insert device is used with a charcoal-type cooking grill to maintain the grill insert's position inside the housing of the cooking grill. FIG. 3 illustrates the stand-offs 62 supporting the base plate 36 on top of a fire grate 60 on which a heat collector 32 (e.g., lava rocks or charcoal briquettes in this figure) is disposed. In use, the base plate 36 is placed closely above the heat source 26 with its bottom surface 40 interfacing in heat communication with the heat source 26.

As shown in FIGS. 2A and 2B, the heat exchanger component 44 has an upper surface 46, a lower surface 56 and a perimeter 47 edge. The upper surface 146 of the heat exchanger 44 has flow features 48 in it to facilitate the flow of liquids (e.g., drippings) that fall onto it toward a perimeter edge 47. These flow features 48 can be channels, grooves, corrugations or the like which are in liquid flow communication with the perimeter edge 47. The lower surface 56 of the heat exchanger 44 closely interfaces in heat communication with the top surface 38 of the base plate 36. The heat exchanger 44 receives heat from the base plate 36 and communicates it to the food support 23 in the cooking area of the cooking grill. Preferably, the heat exchanger 44 is made of cast iron. The overall surface area of the present insert device 30 can be substantially similar to the full surface area of the heat source 26 as shown in FIG. 2A. Alternatively, as shown in FIGS. 1A and 1B, the overall surface area of the present insert device 30 may be less than that of the heat source 26, to allow part of food the support 23 to be directly heated by the heat source 26, or to allow direct access to the heat source 26, e.g., to expose wood chips 24 to the heat source.

A drip edge 52 is disposed along the perimeter edge 47 of the heat exchanger 44. The drip edge 52 can merely be an open edge 52 of the heat exchanger to allow drippings to fall from the channels 48 into the cooking grill housing 14. Alternatively, the drip edge 52 includes a trough 54 along the perimeter edge 47 in which drippings collect as they pass from the flow feature or channels 48. Where the drip edge 52 includes a trough 54 in which drippings collect as they pass from the channels 48, the trough 54 may have a passage or opening 58 through which the dripping can pass from the device 30 into a separate container or into the bottom of the grill housing 14.

In use, the present grill insert 30 is designed to sit over the cooking grill's heat source 26 and to evenly distribute heat to the food grill 23 of the cooking area by means of a heat exchanger 44. The present insert device 30 is intended to have a planar configuration. Also, the insert device 30 is intended in one embodiment to have a surface area substantially corresponding to the surface area and configuration of either the food grill 23 or the heat source 26. Either of these configurations allow the insert device 30 to catch drippings from any part of the cooking area.

Optionally, as shown in FIGS. 1A & 1B, a portion of the space between the heat source 26 and the food grill 23 can be left without having the grill insert 30 between them. In this configuration, the insert device 30 can have a surface area that is less than the surface area of the cooking area, sufficient to allow a portion of the food grill 23 to be subject to direct heating by the heat source 26. This space can be utilized, for example, to cook foodstuffs which do not drip, or to place materials like wood chips 24 (e.g., hickory, mesquite, etc.) for smoking or adding flavors to the cooking foodstuff 28.

As shown in FIG. 2A, the corrugations or channels 48 disposed in the upper surface 46 of the heat exchanger 44 conduct the fluid drippings from the cooking foodstuff 28 to one or more drain means for removing the drippings from the top surface 46 heat exchanger 44. The draining means are disposed along one or more perimeter edges 47 of the heat exchanger 44. Conducting the fluid drippings to the drain means via the corrugations or channels 48 prevents the accumulation or build-up of drippings on the heat exchanger 44. The drain means can be an open drip edge 52 of the heat exchanger 44 which allows the drippings to fall from the channels at the peripheral edge 47 of the heat exchanger 44 into the cooking grill housing 14. In the embodiment shown in FIG. 2A, the heat exchanger 44 has a 90 degree bend along one peripheral edge creating an overhang 50. The overhang 50 somewhat restricts the movement of the heat exchanger 44 relative to the base plate 36. Additionally, the overhang 50 can provide a path for conducting the drippings from the upper surface 46 of the heat exchanger 44 away from the heat source 26 as they fall into the housing 14.

Alternatively, as also shown in FIG. 2A, an end of the corrugations 48 can terminate into a drip edge trough 54. Optionally, the drip trough 54 can include a drip aperture 58 to conduct liquid dripping collected off of the upper surface 46 of the heat exchanger 44 and away from the heat source 26 and into the housing 14. In the embodiment shown in FIG. 2A, both the drip overhang 50 and the drip trough 54 with drip aperture 58 allow the drippings channeled by the corrugations 48 to either side of the grill insert 30 to fall harmlessly away from the heat source 26.

As shown in FIGS. 1A & 1B, the grill insert 30 fits into the housing 14 of a typical cooking grill 10. As an alternative to practicing the present invention 30 as an insert device accessory, it can be practiced by incorporation into such a cooking grill 10 on manufacture as well. In such case, the housing 14 of the cooking grill 10 contains a heat source 26 and a cooking area generally defined by a food grate or panel 23 for supporting foodstuffs 28 over the heat source 26. A lid 18 can be included and attached to the housing 14 as exemplified in the figure. In FIG. 1A, the lid 18 lid is shown in an open position, and is closeable by means of a handle 20. The housing/lid combination (14 & 18) can be provided on a stand or cart (not shown).

As also shown in FIGS. 1A & 1B, optionally, the present grill insert 30 does not have to be configured to fully correspond to the entire cooking area represented by the food grate 23. For example, as shown in the figures, the grill insert 30 can optionally have an area substantially smaller than the food grate 23. This section of the food grate 23 can be used to cook foodstuff 28 that does not drip, or that the user wishes to expose more directly to the heat source 26 of the cooking grill 10, as shown in FIGS. 1A & 1B. Further, wood chips 24 may be placed in the heat source 26 in this section to provide for smoking or flavoring of the foodstuff 28. As shown in FIG. 1B, the grill insert 30 is positioned in close proximity to the heat source 26.

As shown in FIGS. 2A and 2B, the grill insert 30 comprises a base plate 36 and a heat exchanger 44. The base plate 36 has a top surface 38 and a bottom surface 40. Preferably, the base plate is made out of steel and has a thickness ranging between about ¼ inch to about 7/16 inch. In a preferred embodiment, the base plate was steel had a thickness of ¼ inch. The bottom surface 40 of the base plate 36 is disposed in close proximity to the heat collectors 32 of the heat source 26. The heat collectors typically rest on a heat source support 60. The heat source support 60 is a metal grate or grating on which the ceramic briquettes or the like in a gas grill 10, or the charcoal briquettes in a charcoal grill 10, rest when serving as heat collectors 32. The heat source support is contained within the housing 14 of the cooking grill 10. The top surface 38 of the base plate 36 closely interfaces with the lower surface 56 of the heat exchanger 44, in heat flow communication. In the preferred embodiment shown, the cross-section of heat exchanger 44 has a corrugated configuration (see FIG. 1B). However, any cross-sectional configuration of a heat exchanger 44 that has flow channels 48 on the upper surface 46 and has a lower surface 56 that intermittently contacts the baseplate 36 in intended as within the scope of the present invention. The practice of such alternate cross-sectional configurations in the present invention is readily within the skill of the ordinary artisan in this field.

As shown in FIG. 3, legs or stand-offs 62 may be utilized to support the base plate 36 on the heat source support 60 to prevent the base plate 36 from coming into direct contact with the heat collectors 32. The stand-offs 62 can act to keep the insert device 30 a set distance above the heat source 26. This is useful particularly when the heat collectors 32 are charcoal briquettes, to keep the base plate 36 from smothering or crushing the charcoal embers as they burn down.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A device for suppressing flame flare-ups in a cooking grill having a heat source and a food support grill comprising:
a base plate made of metal, the base plate having a top surface and a bottom surface, the base plate disposed above and with its bottom surface in close proximity to the heat source;
a heat exchanger, made of metal having an upper surface, a lower surface and a perimeter edge, the upper surface having channels in liquid flow communication with the perimeter edge, the lower surface interfacing in heat communication with the top surface of the base plate; and
a drip edge disposed along the perimeter edge of the heat exchanger.

2. The device of claim 1, wherein the base plate is comprised of steel plate.

3. The device of claim 1, wherein the base plate has a thickness ranging between about ¼ inch to about 7/16 inch.

4. The device of claim 1, wherein the base plate has standoffs affixed to its bottom surface which act to keep the base plate a set distance above the heat source.

5. The device of claim 1, wherein the base plate is about ¼ inch thick.

6. The device of claim 1, wherein the heat exchanger is made of cast iron.

7. The device of claim 1, further comprising the device having a surface area substantially similar to a surface area of the heat source of the cooking grill.

8. The device of claim 1, further comprising the device having a surface area that is substantially similar to a surface area of the food support of the cooking grill.

9. The device of claim 1, further comprising the device having a surface area that is substantially less than the surface area of the cooking area grill.

10. The device of claim 1, wherein the drip edge is open to allow drippings to fall from the channels.

11. The device of claim 1, wherein the drip edge comprises a trough in which drippings collect as they pass from the channels.

12. The device of claim 1, wherein the drip edge comprises a trough in which drippings collect as they pass from the channels, the trough having a passage through which the dripping can pass from the device.

13. A flame flare-up suppressing gas cooking grill comprising:
a housing;
a heat source contained within the housing, the heat source including a gas burner;
a control assembly operatively connecting the gas burner to an external gas source, the assembly operative to supply and control the flow of gas to the heat source;
a food grill positioned above the heat source within the housing; and
a flame flare-up suppressing device disposed in the housing between and in heat communication with the heat source and the food grill.
